(19) United States
(12) Patent Application Publication
(10) Pub. No.: US 2010/0180120 A1
(43) Pub. Date: Jul. 15, 2010

(54) INFORMATION PROTECTION DEVICE

(75) Inventors: Lior Frenkel, Moshav Misgav Dov (IL); Amir Zilberstein, Yad Rambam (IL)

Correspondence Address: D. Kligler I.P. Services LTD, P.O. Box 25, Zippori, 17910, IL

(73) Assignee: HUMAN INTERFACE SECURITY LTD, Rosh Ha'Ayin (IL)

(21) Appl. No.: 12/676,143

(22) PCT Filed: Sep. 3, 2008
(86) PCT No.: PCT/IL08/01187

§ 371 Date: Mar. 3, 2010

(30) Foreign Application Priority Data
Sep. 6, 2007 (IL) 185795
Oct. 7, 2007 (IL) 186473
Nov. 19, 2007 (IL) 187492

(51) Int. Cl. H04L 9/32

(52) U.S. Cl. 713/173

(57) ABSTRACT

A method for communication includes coupling an information protection device (34) to communicate via a local interface (36) with a local computer (28) operated by a user (22), the information protection device having an input transducer (58) associated therewith. A communication session is initiated between the local computer and a remote computer (24) over a network (26). The information protection device receives an access code input by the user via the input transducer and encrypts the access code using an encryption key held by the information protection device. The encrypted access code is conveyed from the information protection device over the local interface to the local computer and from the local computer to the remote computer over the network in order to authenticate the user at the remote.

### FIELD OF THE INVENTION

The present invention relates generally to information security, and specifically to devices and methods for enhancing the security of data communications.

### BACKGROUND OF THE INVENTION

Data encryption is widely used in preventing unauthorized access to data. Various methods of data encryption are known in the art. In general, these methods use a key to convert data to a form that is unintelligible to a reader (human or machine), and require an appropriate key in order to decrypt the data. Symmetric encryption methods use the same key for both encryption and decryption. Such symmetric methods include the well-known DES (Data Encryption Standard) and AES (Advanced Encryption Standard) algorithms. In asymmetric encryption methods, such as the RSA (Rivest Shamir Adelman) algorithm, a computer that is to receive encrypted data generates complementary public and private keys and transmits the public key to the sender. After the sender has encrypted the data using the public key, only the holder of the private key can decrypt it.

### SUMMARY OF THE INVENTION

Modern methods of encryption make it very difficult for a malicious party who intercepts an encrypted message to decrypt the message contents. On the other hand, within the computer that sends or receives the message, the message contents are typically held in clear (unencrypted) form, at least temporarily, in computer memory or storage. A malicious party who gains access to the memory of the computer (using a “Trojan horse” or other “spyware” program, for example) may be able to intercept the message in its internal clear form and tamper with secret message contents (including user passwords and other sensitive private information). As another example, the malicious party may use a key-logger to copy and transmit a record of keystrokes made on the computer keyboard.

Embodiments of the present invention that are described hereinbelow use a novel information protection device, operating in conjunction with a computer, to enhance data security. The device has an input transducer (such as a keypad) and comprises an encryption processor, which are configured to convey authorization and/or other private information to a remote computer, such as a server, in such a way that the information is never available to the local computer in unencrypted form.

In order to send a secure communication to the remote computer, the user connects the information protection device to his or her local computer by a short-range wired or wireless link, and initiates network communication between the local computer and the remote computer. The user inputs private information, such as a password or credit card number, via the input transducer that is associated with the device, which then encrypts the information in a manner that will be indecipherable to the local computer. The device passes the encrypted information over the short-range link to the local computer, which then transmits the encrypted information over the network to the remote computer, which has the key that is needed to decrypt the information.

In some embodiments of the present invention, the encryption key that is used by the information protection device is a public key of the remote computer. The remote computer conveys the public key to the device via the local computer at the beginning of the communication session, and then uses the corresponding private key in order to decrypt the message. In other embodiments, the encryption key is preloaded into the information protection device and optionally may also serve as an identification token to identify the device. Alternatively, the device may use both a public key conveyed by the remote computer and a preloaded identification token. Further alternatively or additionally, the encryption key may be input by the user or transmitted to the information protection device either via the local computer (using a suitable secure key exchange mechanism) or via another communication link.

Using the information protection device in the manner described above, the local computer itself receives the user's sensitive private information (such as an access code) only in an encrypted form, which only the remote computer can decrypt. Therefore, even if a malicious party were to gain access to the local computer, that party would not be able to discover the actual content of the private information. The remote computer may change the key from session to session, so that an encrypted access code that is intercepted by a malicious user in one session is useless for any subsequent session.

There is therefore provided, in accordance with an embodiment of the present invention, a method for communication, including:

coupling an information protection device to communicate via a local interface with a local computer operated by a user, the information protection device including an input transducer;

initiating a communication session between the local computer and a remote computer over a network;

receiving in the information protection device an access code input by the user via the input transducer;

encrypting the access code in the information protection device using an encryption key held by the information protection device;

conveying the encrypted access code from the information protection device over the local interface to the local computer and from the local computer to the remote computer over the network; and

authenticating the user at the remote computer by decrypting the encrypted access code.

In a disclosed embodiment, the method includes conveying, from the information protection device over the local interface to the local computer and from the local computer to the remote computer over the network, an indication of an authentication token stored by the information protection device, wherein authenticating the user includes verifying an identity of the user responsively to the indication. Additionally or alternatively, the method includes receiving in the information protection device a biometric input by the user via a biometric sensor of the information protection device, and conveying an indication of the biometric input from the information protection device over the local interface to the local computer and from the local computer to the remote computer over the network, wherein authenticating the user includes verifying an identity of the user responsively to the indication.

In one embodiment, the input transducer includes a keypad, and the information protection device includes an output transducer, for prompting the user to input the access code. The method may include conveying a certificate from the remote computer over the network to the local computer and verifying that the certificate is valid, wherein prompting the user includes outputting via the output transducer an indication that the certificate is valid.

Typically, the method includes, after authenticating the user, receiving information from the user via a user interface of the local computer for transmission from the local computer to the remote computer in the communication session. Additionally or alternatively, the method includes, after authenticating the user, receiving in the information protection device further information that is input by the user via the input transducer, and transmitting the further information in an encrypted form from the information protection device to the remote computer via a tunneled logical path through the local computer.

Coupling the information protection device may include plugging the information protection device into a receptacle in the local computer or establishing a short-range wireless link between the information protection device and the local computer.

In some embodiments, encrypting the access code includes conveying the encryption key from the remote computer over the network to the local computer and from the local computer over the local interface to the information protection device.

There is also provided, in accordance with an embodiment of the present invention, a method for communication, including:

coupling an information protection device to communicate via a local interface with a local computer operated by a user, the information protection device including an input transducer;

establishing a physical communication link over a network between the local computer a remote computer over a network;

setting up a secure tunnel between the remote computer and the information protection device via the physical communication link and through the local computer, such that information transmitted through the secure tunnel is encrypted and can be decrypted only using a key that is unavailable to the local computer;

receiving data input by the user to the information protection device via the input transducer; and

encrypting and transmitting the data from the information protection device to the remote computer via the secure tunnel.

In some embodiments, the data input by the user via the input transducer include first data, and the method includes receiving second data input by the user via a user interface of the local computer, and transmitting the second data together with the first data to the remote computer via the physical communication link in a single communication session. Typically, the input transducer includes a keypad, and the user interface includes a keyboard. In one embodiment, the secure tunnel includes a first secure socket connection, and transmitting the second data includes setting up a second secure socket connection between the information protection device and the local computer, and conveying the second data from the local computer through the second secure socket connection to the information protection device and from the information protection device through the first secure socket connection to the remote computer.

In disclosed embodiments, receiving the data includes presenting a page provided by the remote computer on a display of the local computer, the page including a field to be filled in with the data input by the user. In one embodiment, the secure tunnel includes a first secure socket connection, and presenting the page includes setting up a second secure socket connection between the information protection device and the local computer, and conveying the page from the remote computer through the first secure socket connection to the information protection device and from the information protection device through the second secure socket connection to the local computer. Presenting the page may include generating an indication on the display that the field is to be filled in by the user by means of the input transducer of the information protection device.

There is additionally provided, in accordance with an embodiment of the present invention, a system for authenticating a user of a local computer, the system including:

a remote computer, which is configured to communicate over a network with the local computer; and

an information protection device, which includes:

a communication interface for communicating with a local interface of the local computer;

an input transducer, which is coupled to receive an access code that is input by the user; and

an encryption processor, which is configured to encrypt the access code using an encryption key held by the information protection device and to convey the encrypted access code via the local interface to the local computer for transmission by the local computer to the remote computer over the network,

wherein the remote computer authenticates the user by decrypting the encrypted access code.

Typically, the input transducer is selected from a group of input transducers consisting of a keypad and a keyboard. In one embodiment, the input transducer is configured to convey unencrypted input to the local computer responsively to keystrokes by the user, wherein the information protection device includes a switch that is operable to determine whether to convey data to the local computer responsively to the keystrokes in encrypted or unencrypted form.

In some embodiments, the information protection device includes a housing that contains the input transducer. Alternatively, the input transducer includes an output connector, and the information protection device includes an input connector for receiving the output connector.

There is further provided, in accordance with an embodiment of the present invention, a system for communication by a user of a local computer, the system including:

a remote computer, which is configured to establish a physical communication link with the local computer over a network; and

an information protection device, which includes:

a communication interface for communicating with a local interface of the local computer;

an input transducer, which is coupled to receive data that are input by the user; and

a processor, which is configured to set up a secure tunnel to the remote computer over the physical communication link via the local computer, and to encrypt the received data for transmission via the secure tunnel to the remote computer such that the encrypted data transmitted through the secure tunnel can be decrypted only using a key held by the remote computer that is unavailable to the local computer.

There is moreover provided, in accordance with an embodiment of the present invention, an information protection device, for authenticating a user of a local computer on a remote computer, the device including:

a communication interface for communicating with a local interface of the local computer;

an input transducer, which is coupled to receive an access code that is input by the user;

a memory, which is configured to hold an encryption key; and

an encryption processor, which is configured to encrypt the access code using the encryption key and to convey the encrypted access code via the local interface to the local computer, so as to cause the encrypted access code to be conveyed via the local computer over the network to the remote computer, for authentication of the user by decryption of the encrypted access code.

There is furthermore provided, in accordance with an embodiment of the present invention, an information protection device for use by a user of a local computer, which is in communication with a remote computer via a physical communication link over a network the device including:

a communication interface for communicating with a local interface of the local computer;

an input transducer, which is coupled to receive data that are input by the user; and

a processor, which is configured to set up a secure tunnel to the remote computer over the physical communication link via the local computer, and to encrypt the received data for transmission via the secure tunnel to the remote computer such that the encrypted data transmitted through the secure tunnel can be decrypted only using a key held by the remote computer that is unavailable to the local computer.

There is also provided, in accordance with an embodiment of the present invention, an information protection device, for authenticating a user of a local computer on a remote computer, the device comprising:

a communication interface for communicating with a local interface of the local computer;

an input connector, which is configured to receive an output connector of an input transducer, which is operable by the user to input an access code;

a memory, which is configured to hold an encryption key; and

an encryption processor, which is configured to encrypt the access code using the encryption key and to convey the encrypted access code via the local interface to the local computer, so as to cause the encrypted access code to be conveyed via the local computer over the network to the remote computer, for authentication of the user by decryption of the encrypted access code.

There is additionally provided, in accordance with an embodiment of the present invention, an information protection device, for authenticating a user of a local computer on a remote computer, the device comprising:

a communication interface for communicating with a local interface of the local computer;

an input connector, which is configured to receive an output connector of an input transducer, which is operable by the user to input data; and

a processor, which is configured to set up a secure tunnel to the remote computer over the physical communication link via the local computer, and to encrypt the received data for transmission via the secure tunnel to the remote computer such that the encrypted data transmitted through the secure tunnel can be decrypted only using a key held by the remote computer that is unavailable to the local computer.

The present invention will be more fully understood from the following detailed description of the embodiments thereof, taken together with the drawings in which:

### BRIEF DESCRIPTION OF THE DRAWINGS

FIG. 1 is a schematic pictorial illustration of a system for secure data communications, in accordance with an embodiment of the present invention;

FIG. 2 is a schematic pictorial illustration of an information protection device, in accordance with an embodiment of the present invention;

FIG. 3A is a schematic pictorial illustration of an information protection device, in accordance with another embodiment of the present invention;

FIG. 3B is a block diagram that schematically shows functional components of the device of FIG. 3A, in accordance with an embodiment of the present invention;

FIG. 4 is a flow chart that schematically illustrates a method for secure communications, in accordance with an embodiment of the present invention;

FIG. 5 is a schematic pictorial illustration showing physical and logical communication paths in a secure communication system, in accordance with an embodiment of the present invention;

FIG. 6 is a flow chart that schematically illustrates a method for secure transmission of secret data, in accordance with an embodiment of the present invention;

FIG. 7 is a schematic pictorial illustration of an information protection device, in accordance with another embodiment of the present invention; and

FIG. 8 is a schematic pictorial illustration of an information protection device, in accordance with an alternative embodiment of the present invention.

### DETAILED DESCRIPTION OF EMBODIMENTS

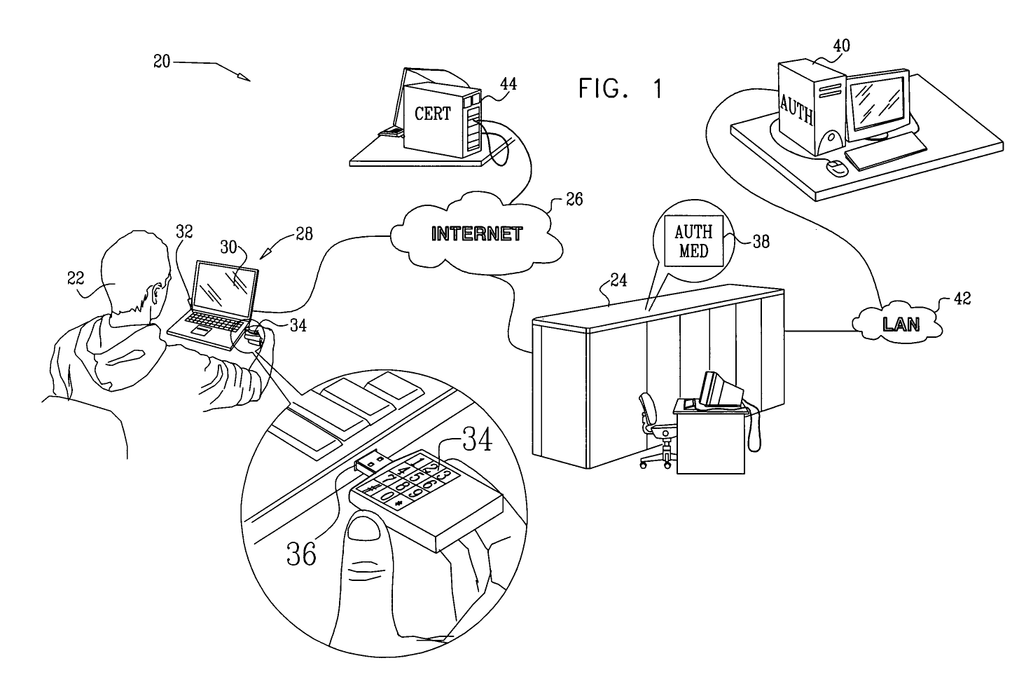

FIG. 1 is a schematic pictorial illustration of a system 20 for secure data communications, in accordance with an embodiment of the present invention. In a typical scenario, a user 22 operates a personal computer 28 to establish a communication session with a remote server 24 over a network 26, such as the Internet. Computer 28 comprises user interface components, such as a display 30 and a keyboard 32, which user 22 employs in the communication session. Personal computer 28 and remote server 24 are examples, respectively, of a local computer and a remote computer that may be used in this embodiment, but the principles of the present invention may similarly be implemented using any suitable types of computing devices that communicate over substantially any type of network. For example, the “local computer” may comprise a mobile telephone or personal digital assistant (PDA) with suitable computing and communication capabilities, while the network comprises a cellular network.

In preparation for establishing the communication session, user 22 couples an information protection device 34 via a local interface to computer 28. In this case, the local interface comprises a mating receptacle 36, such as a Universal Serial Bus (USB) port in computer 28, and the user couples device 34 to computer 28 by making a physical connection with the port. Alternatively, any other suitable sort of local interface may be used, including both wired interfaces (such as the USB or other port) and wireless interfaces, such as a Bluetooth™ or other radio interface or an infrared interface. The term “local” in this context is used to refer to interfaces that operate over short ranges, in the sense that both computer 28 and device 34 are in physical reach of user 22 simultaneously.

In operation of system 20, as described in greater detail hereinbelow, device 34 uses an encryption key to encrypt information input by a user. In one embodiment, which is described in detail hereinbelow, server 24 sends an encryption key over network 26 to computer 28, which then passes the key to an encryption processor in device 34. Typically, this encryption key is a public key, for which the server holds the corresponding private key, although other types of encryption keys may also be used. To deter hackers, the server may generate and transmit a new key for each communication session or set of sessions. Alternatively, device 34 may store and use a pre-loaded key or may receive the key by other means, so long as the key and encryption method are such that the necessary decryption key is not readily available on computer 28.

User 22 inputs a designated password (or other access code) to device 34, which encrypts the password using the key and passes the encrypted password back via computer 28 to server 24.

In the server, an authentication mediator 38 component is responsible for communicating with device 34, including transmission of the public key and decryption of the user password using the corresponding private key. Optionally, device 34 may comprise a unique token (typically in the form of a secret numerical code, stored in read-only memory in the device) that identifies user 22, and the authentication mediator may also check this token to verify that it is valid and matches the user password. The token itself may also be used in encrypting information in device 34. If server 24 belongs to an organization that maintains a central user authentication server 40, authentication mediator 38 may communicate with this server, over a local area network (LAN) 42, for example, in order to exchange information and sign user 22 in for access to organization resources. Alternatively, server 24 may operate on a standalone basis, with or without a dedicated authorization mediator.

In order to prevent malicious parties from interacting with device 34 (by spoofing the identity of server 24, for example), a certification server 44 may be used to verify the identity of the party supplying the public key to computer 28. For this purpose, server 24 is required to present a digital certificate, which is verified by server 44 before user 22 inputs the password to device 34. Typically, when a verification message is received from server 44, it causes device 34 to output a sign or message to the user in order to indicate that the computer requesting the encrypted password is bona fide, whereupon the user may input the password. These functions are described in greater detail hereinbelow.

Typically, computer 28 and server 24 are general-purpose computers, which are programmed in software to carry out the functions that are described herein. This software may be downloaded to the appropriate computer in electronic form, over a network, for example, or it may alternatively be provided on tangible media, such as magnetic, optical or electronic memory media.

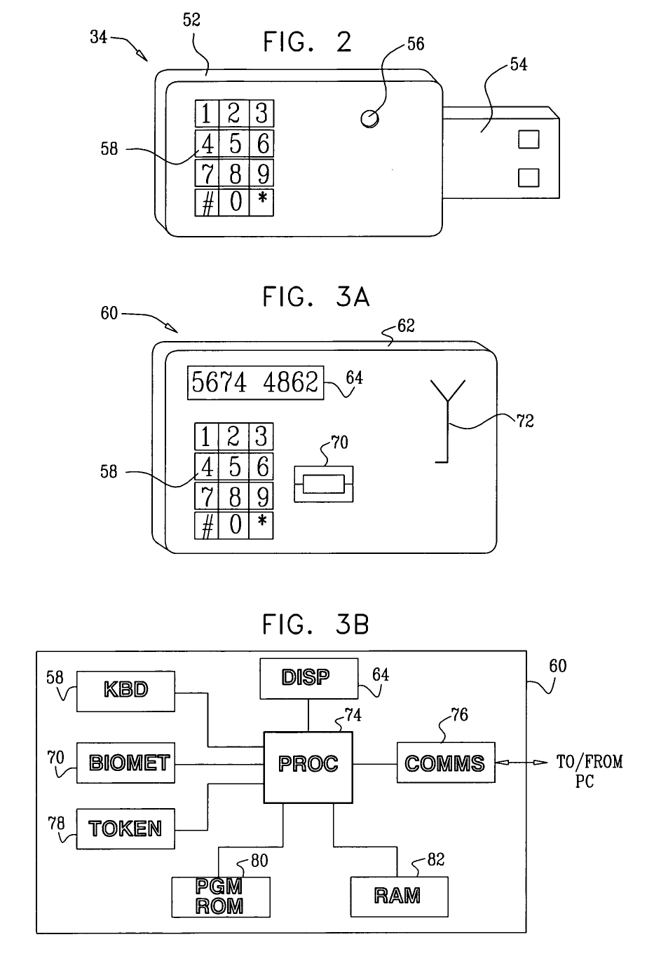

FIG. 2 is a schematic, pictorial illustration showing details of information protection device 34, in accordance with an embodiment of the present invention. In this version, the information protection device comprises a housing 52 with a USB connector 54, at least one output transducer in the form of an indicator lamp, such as a light-emitting diode (LED) 56, and an input transducer in the form of a keypad 58. The user of information protection device 34 uses the keypad, as explained above, to input the appropriate access code. The user may also operate the keypad during a secure communication session to input other information, such as a credit card number, that is to be encrypted by the information protection device before being transmitted via computer 28 to server 24.

LED 56 (or another output transducer) may serve several functions, including indicating to the user that he or she should input the appropriate number via the keypad. The LED may flash green, for example, to indicate that certification server 44 has verified the entity requesting the user's access code. Alternatively or additionally, the output transducer may comprise an alphanumeric or graphical display, such as a flat-panel liquid crystal display (LCD), or an audio output device, or any other suitable type of output device that is known in the art. Similarly, the input transducer may comprise additional keys, a tactile pointing device, an audio input device, a biometric sensor (as shown in FIG. 3A), or any other suitable type of input device that is known in the art.

Reference is now made to FIGS. 3A and 3B, which schematically illustrate an information protection device 60, which may be used in system 20 in place of device 34, in accordance with another embodiment of the present invention. FIG. 3A is a pictorial illustration of device 60, while FIG. 3B is a block diagram showing functional components of the device. Similar functional components are used, mutatis mutandis, in device 34. Although FIGS. 2, 3A and 3B show examples of information protection devices with certain specific combinations of features, other information protection devices for use in system 20 may have different combinations and implementations of such features, as will be apparent to those skilled in the art.

Information protection device 60 comprises a housing 62, which may comprise a laminated coating with the shape and form factor of a credit card or smart card. The output transducer in this embodiment comprises a flat panel display 64, such as a LCD, while the input transducers include a keypad 68 and a biometric sensor 70, such as the type of optical fingerprint sensor that is used for user authentication on many personal computers. A radio-frequency (RF) antenna 72, which is typically embedded in housing, serves a short-range wireless communication interface 76, such as a Bluetooth™ interface, over which device 60 communicates with computer 28.

As shown in FIG. 3B, information protection device 60 comprises an embedded encryption processor 74, which operates in accordance with program instructions that are stored in read-only memory (ROM) 80 within housing 62. Processor 74 may comprise a general-purpose microprocessor or microcontroller device. Additionally or alternatively, processor 74 may comprise a special-purpose processor, such as a reduced-instruction-set computer (RISC) device or a hardware accelerator for encryption functions. ROM 80 may comprise a programmable type of ROM, such as Flash ROM, to permit the software to be updated from time to time. Device 60 also comprises a random-access memory (RAM) 82, in which processor 74 holds the public key that it receives from server 24, as well as other data used in the processes of communication and authentication. Alternatively, one or more encryption keys may be pre-loaded into ROM 80 for subsequent use by the device.

Optionally, a token 78 may be stored in ROM within housing 62, either within ROM 80 or in a separate memory. Token 78 is a unique identifier, similar to the security key that is stored in subscriber identity module (SIM) devices. This token is associated with user 22 and is used by server 24 in authenticating the user, as described hereinbelow. Optionally, as noted earlier, the token may also serve as an encryption key. Alternatively, in some embodiments, no token is used at all in the information protection device.

Although device 60 is shown in FIG. 3B, for the sake of conceptual clarity, as comprising certain distinct functional blocks, the blocks do not necessarily reflect the physical components that are used in actual implementations of the device. Rather, certain blocks may be combined within a single integrated circuit (IC) component. On the other hand, certain blocks may be implemented using two or more different components. All such implementations are considered to be within the scope of the present invention.

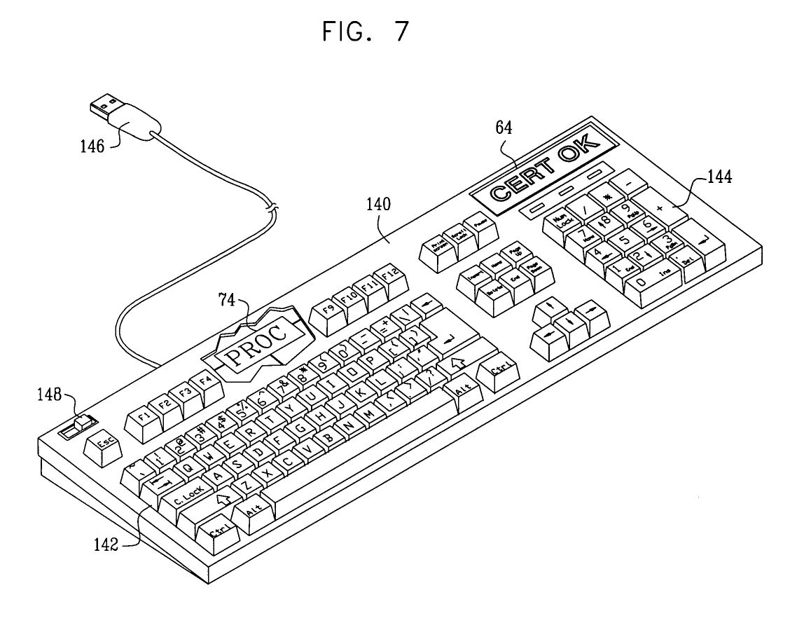

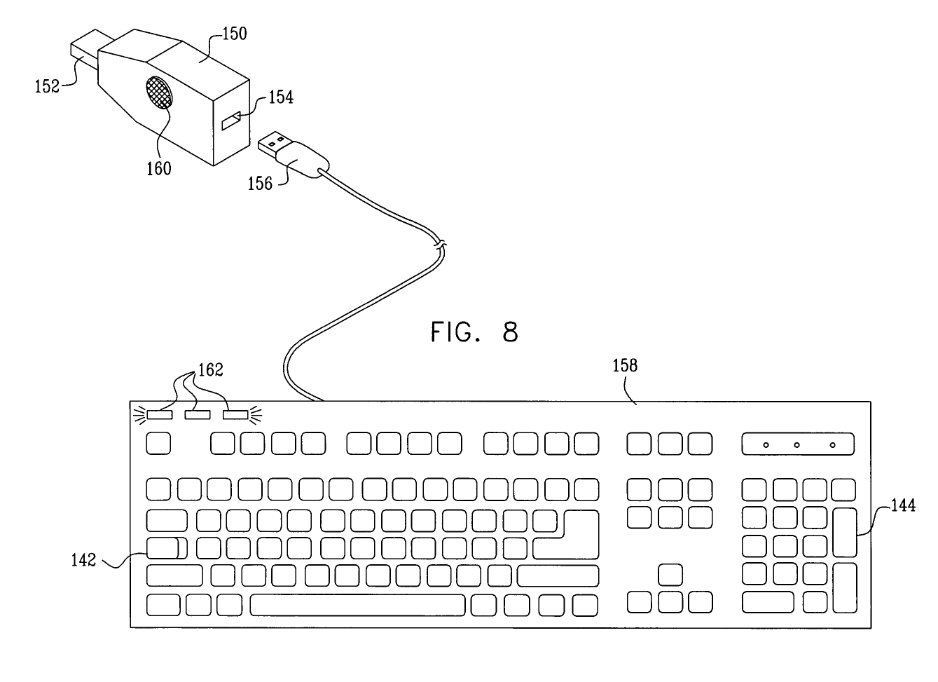

Other types of information protection devices that may be used in system 20 in place of device 34 or device 60 are described hereinbelow with reference to FIGS. 7 and 8.

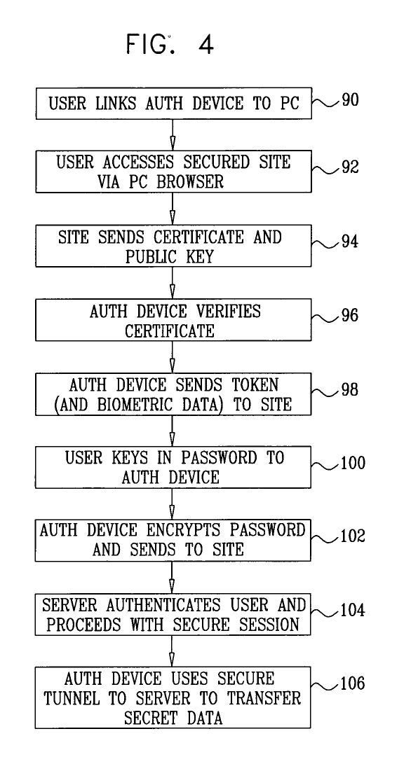

FIG. 4 is a flow chart that schematically illustrates a method for secure communications, in accordance with an embodiment of the present invention. The method is described below, by way of example, with reference to information protection device 60 (rather than device 34) and the other components of system 20 (FIG. 1). Alternatively, the method may be implemented in substantially any sort of computer system in which the user of a local computer is to be authenticated by a remote computer, and using any sort of information protection device that has the properties set forth hereinabove.

To initiate communications with server 20, user 22 couples information protection device 60 to communicate locally with computer 28, at a device linking step 90. The coupling may take the form of physically plugging the information protection device into the computer or simply bringing the information protection device into proximity with the computer so that a short-range wireless link may be established. A suitable driver program is typically pre-installed in computer 28, which causes the computer to recognize and interact with device 60 in the appropriate manner during the steps of the method described hereinbelow. Alternatively, the information protection device may contain a program in memory that runs automatically on computer 28 when the device is plugged into the computer, so that the computer can interact with the device in the desired manner without previous software installation.

User 22 operates computer 28 to access server 24, at an access step 92. For example, the user may navigate to a Web site run by the server using the browser program on computer 28. Assuming server 24 to belong to a bank, for instance, the user might access the bank's Web site, and then click an on-screen button to log into banking services for the user's personal account. In response, server 24 transmits a public key over network 26 to computer 28, at a key transmission step 94. Computer 28 passes the public key to information protection device 60 via the local interface for use as described hereinbelow. Alternatively, as noted earlier, the encryption key to be used by the information protection device may be pre-loaded or transmitted to device 60 by other means, in which case step 94 may be omitted.

In addition to transmitting the public key at step 94, server 24 may also transmit a digital certificate, attesting to the authenticity of the server, i.e., that this server really does belong to the user's bank, for instance, rather than to a hacker masquerading as the bank. Computer 28 and/or authorization device 60 may then take one or more steps to verify that the certificate is valid, at a certification checking step 96. For example, computer 28 may pass the certificate to device 60, which then extracts the name and owner information from the certificate and outputs the information to display 64. User 22 checks that the information appearing on the display conforms with the details of the proper Web site and organization before proceeding to input any personal data. Because the certificate is processed and displayed by device 60, rather than computer 28, it is less likely to be corrupted by a malicious program that may have been installed in the computer unbeknownst to the user.

Additionally or alternatively, the certificate sent by server 24 may be verified at step 96 by communication between computer 28 and certification server 44. Server 44 typically belongs to a certification authority (CA), which issues the certificate to server 24 (and to other sites) and maintains up-to-date information regarding the validity or revocation of the certificate. Certification server 44 may communicate with the browser program on computer 28 using standard certification protocols that are known in the art. Alternatively or additionally, the certification server may communicate with information protection device 60 (via computer 28) using a proprietary protocol, so that the verification of certification is conveyed directly to the information protection device. In either case, upon successful verification of the certificate by server 44, device 60 displays a message or other indication that server 24 has been verified. In the case of device 34, for example, the indication may take the form of lighting LED 56 in a prescribed manner, as noted above.

Optionally, processor 74 in device 60 may lock output communications from the device until the certificate of server 24 has been verified. User 22 may be able to override the lock, however, by entering a certain sequence of keystrokes, for example, if necessary.

Typically, once server 24 has been satisfactorily verified, processor 74 in information protection device 60 transmits an indication of token 78 to server 24, at a token transmission step 98. This indication may be transmitted in various ways. For example, device 60 may simply transmit the token itself, or may encrypt the token for transmission using the public key that it received at step 94. As another alternative, processor 74 may use the token in a challenge-response authentication procedure, such as the type of procedure that is used for subscriber authentication in cellular networks.

In addition to or instead of transmitting the token at step 98, processor 74 may prompt the user to input biometric data via sensor 70. The processor may then transmit this data via computer 28 to the authentication mediator as another means for verifying the identity of user 22.

Alternatively, as noted earlier, step 98 may be omitted entirely. In such cases, server 24 may identify the user solely on the basis of a user name or other identity data, which may be input via computer 28.

User 22 keys in his or her password via keypad 68, at a password entry step 100. This step likewise follows verification of server 24 at step 96 and may take place in parallel with or before step 98. Typically, processor 74 prompts the user to input the password by outputting a suitable message to display 64. Additionally or alternatively, a suitable message may appear on display 30 of computer 28. Processor 74 encrypts the password using the public key that it received at step 94 (or alternatively using token 78 or another suitable key). The processor then conveys the encrypted password via interface 76 to computer 28. Thus, computer 28 is never exposed to the password in unencrypted form and does not have access to the private key that is needed to decrypt the password.

Server 24 receives the encrypted password, at a user authentication step 104. Authentication mediator 38 decrypts the password and checks that it matches the user identity. Assuming that a token indication was transmitted at step 98, the authentication mediator may check the token against a list of issued tokens in order to identify the user and to verify that the token is authentic and has not been revoked. Additionally or alternatively, the authentication mediator may check the user's biometric data. Further alternatively or additionally, server 24 may check the decrypted password against the user name or other identity data provided by computer 28, in addition to or instead of checking the token and/or biometric data.

Upon verifying the user's identity and password, authentication mediator 38 may sign the user in to authentication server 40, and will then proceed to conduct a secure communication session with computer 28. Such sessions are commonly conducted over the Internet using the Secure Socket Layer (SSL) protocol, which provides for secure encryption of all data transmitted between computer 28 and server 24.

SSL and other encrypted communication solutions, however, do not solve the problem of unencrypted data within computer 28. Thus, for example, when user 22 is prompted to input a credit card number, personal identification number (PIN), or other secret account information to computer 28 via keyboard 32, a malicious party may be able to gain access to this information before it is encrypted, by means such as “phishing,” a Trojan horse, or other spyware planted on the computer.

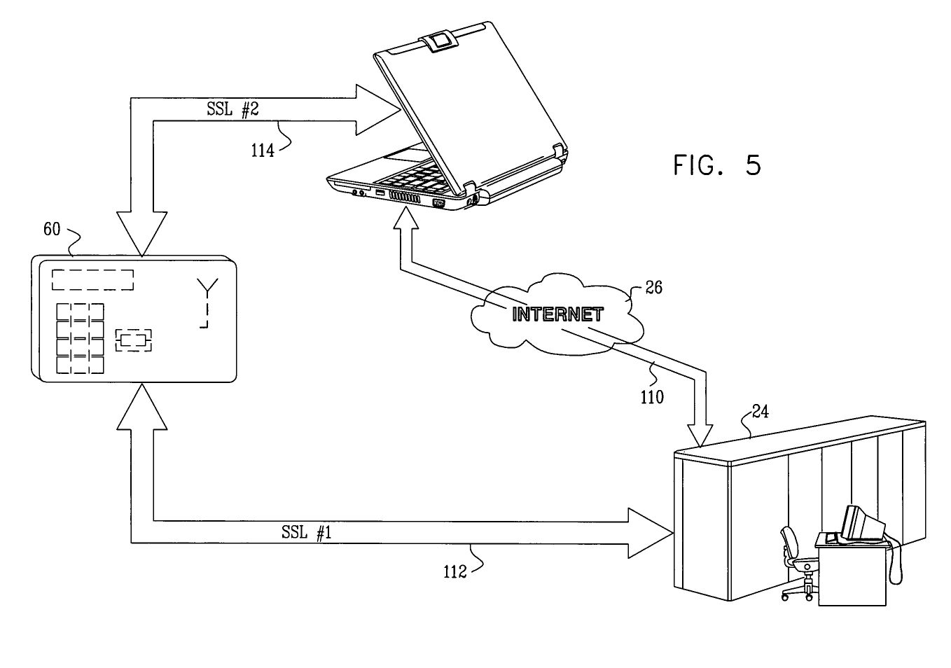

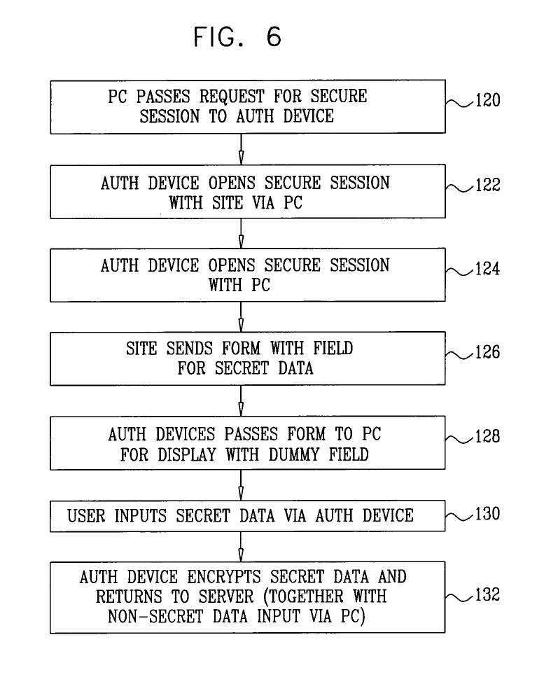

In order to prevent this sort of exposure of secret information, processor 74 in information protection device 60 may establish a secure tunnel for transmission of encrypted data to server 24, at a tunneling step 106. At this step, user 22 keys in secret information via keypad 68, and processor 74 encrypts the information before passing it to computer 28 for transmission to the server. Therefore, a malicious party who may intercept the information on computer 28 will still be unable to decrypt and make use of the information. The encryption at step 106 may use the public key that was received at step 94, or it may alternatively use any other suitable key and encryption technique. Details of step 106 are described hereinbelow with reference to FIGS. 5 and 6.

FIG. 5 is a schematic pictorial illustration showing physical and logical communication paths used for SSL tunneling in system 20, in accordance with an embodiment of the present invention. Communications between information protection device 60 and server 24 are carried over a physical communication path 110 between computer 28 and server 24 via network 26. In order to convey secret information over physical path 110 without exposing the information on computer 28, processor 74 on device 60 opens a secure logical path 112 directly from device 60 to server 24. Although logical path 112 is carried physically via interface 76 to computer 28, and through the computer over physical path 110 to the server, the information transmitted over the logical path is encrypted in a manner inaccessible to computer 28. For example, logical path 112 may comprise a SSL connection between device 60 and server 24, which “tunnels” transparently through computer 28. Computer 28 merely relays the packets transmitted over path 112, without being able to read or alter the higher-level protocol headers and payload data in these packets.

Because of the limited display and data input capabilities of information protection device 60, it is still desirable that user 22 be able to see information (such as Web pages) on display 30 and to input non-secret information via keyboard 32 of computer 28. For this purpose, processor 74 may open a second logical path 114, which may also be a SSL connection, between device 60 and computer 28 via interface 76. Processor 74 then passes information over path 114 for display by computer 28. Thus, device 60 can serve as a sort of SSL proxy between computer 28 and server 24. When device 60 encounters a Web page containing a field for secret data (such as a credit card number or PIN), for example, it prompts the user to input the required information via keypad 68 and blanks out the field on display 30. Other than such fields, Web pages are displayed and behave in the normal fashion on computer 28.

In order to reduce the computational load on device 60, which might otherwise be a bottleneck in communications between computer 28 and server 24, computer 28 may open a separate socket directly to server 24 (not shown in FIG. 5). This direct socket may then be used, for example, for Web pages that do not contain fields for secret data. In the course of a communication session with computer 28 over this direct socket, server 24 may direct computer 28 to transfer the session to device 60 before transmitting a page containing a field for secret data. In such a case, computer 28 will pass the session information (such as any relevant cookies) to device 60. The device will use the session information in opening new SSL sessions over logical paths 112 and 114 in order to continue the interaction between server 24 and computer 28. Opening the new SSL session (rather than simply continuing the previous session between the computer and the server) ensures that the information carried over path 112 will be encrypted in a manner that is unintelligible to computer 28.

In an alternative embodiment, the secure tunnel that is provided by logical path 112 between device 60 and server 24 may be used without the addition of logical path 114. This configuration may provide a less convenient and less intuitive user interface, but it can still be effective as long as the user is conscious of the need to input secret information via keypad 68, rather than keyboard 32.

The techniques of SSL tunneling that are shown in FIGS. 5 and 6 are described herein, for the sake of convenience, with reference to the same system 20 and information protection device 60 as in the method of FIG. 4. Indeed, the data security that is provided by SSL tunneling is a natural complement to the techniques of authentication security that are described above. On the other hand, the methods of FIGS. 5 and 6 are not dependent on any particular method of authentication and may be carried out independently of the method of FIG. 4.

FIG. 6 is a flow chart that schematically illustrates a method for secure transmission of secret data in the scenario of FIG. 5, in accordance with an embodiment of the present invention. The method is initiated when a requirement to establish a secure session is detected in communications between server 24 and computer 28, at a session detection step 120. For example, computer 28 may detect a request from server 24 for Hypertext Transfer Protocol (HTTP) communication over SSL (commonly referred to as HTTPS). Such a request may be detected by a suitable agent or other program installed on computer 28, such as a browser plug-in or a Layered Service Provider (LSP) type of dynamic-link library (DLL). Alternatively or additionally, after login and authentication using device 60, as described above, server 24 may prompt computer 28 directly to transfer the session to the device.

Before opening the requested session, processor 74 in device 60 verifies that the request is authentic. Such verification is typically based on a certificate presented by server 24, as at steps 94 and 96 in FIG. 4. Alternatively, if processor 74 already verified the server at login, it may not be necessary to repeat the procedure following step 120.

After verifying the session request, processor 74 opens a secure session with the server, at a server session establishment step 122. As explained above, this session tunnels through computer 28 over logical path 112. Processor 74 also opens a secure session with computer 28 over logical path 114, at a local session establishment step 124. As explained above, this latter session will enable computer 28 to receive and display the Web pages transmitted by server 24 over path 112. To avoid problems in displaying the pages using the browser on computer 28, processor 74 may generate and convey to computer 28 a temporary certificate indicating that the source of the Web pages is a recognized, secure site. For this purpose, it is desirable that the browser on computer 28 be configured to recognize device 60 as a trusted certification authority.

Communications between computer 28 and server 24 proceed normally via device 60 until processor 74 recognizes a field in a form transmitted by the server that is to be filled in with secret information, at a field detection step 126. The server may mark such fields, for example, with a suitable identifying flag, which is recognized by processor 74 in the course of receiving and transmitting the pages. Alternatively or additionally, the processor and/or an agent on computer 28 may recognize such fields automatically, possibly on the basis of the field names in the Web page. Further alternatively or additionally, the user of computer 28 may recognize and mark such fields.

Processor 74 substitutes a dummy field for the field that is to be filled in with secret information, at a field substitution step 128. The field is marked with an identification code, which is recognized by the agent running on computer 28. The dummy field may contain a message or other indicator reminding the user to enter the information in this field via the keypad of device 60. Additionally or alternatively, device 60 may output a prompt on display 64.

The user inputs the required information via keypad 68, at a secret data input step 130. Processor 74 saves the information in memory 82 with an index corresponding to the identification code that was assigned to the field. Optionally, this information may be encrypted using a key provided for this purpose by server 24, such as the public key that was transmitted at step 94 (FIG. 4). Alternatively, the native encryption provided by SSL may provide sufficient data security without additional encryption. As the user keys in the data to keypad 68, the processor may instruct the agent on computer 28 to fill in the corresponding field on display 30 with dummy characters, such as asterisks, as though the user had typed in the information on keyboard 32. If there are other, non-secret fields on the same page, the user may enter the required data into these fields in the normal way using keyboard 32. When the user clicks on the appropriate control (such as “OK” or “SEND”), computer 28 passes these data to device 60.

Processor 74 transmits the encrypted secret information to server 24 over path 112, together with the data (if any) from the same page that was passed to device 60 by computer 28, at a data return step 132. The data returned to the device by the computer contains the identification code indicating the field of secret information that was entered via keypad 68. Before transmitting the data to server 24, processor 74 uses the identification code to retrieve the appropriate secret information and substitutes it for the code in the message to the server. As noted earlier, although path 112 passes through computer 28, the information carried over the path is encrypted in a way that is unintelligible to the computer.

In some cases, server 24 may echo secret information back to computer 28 via device 60. For example, the server may send instructions to display a credit card number that the user has keyed in, and to present the question, “Are you sure this credit card number is correct?” The occurrence of such an echoed field (or any other field containing secret information transmitted by the server) may be detected by device 60 and/or computer 28 in the manner described above. Upon detecting such a field, processor 74 substitutes an identification code for the contents of the field, and computer 28 shows a dummy field on display 30, which does not contain the secret information. When the user selects this field, the agent on computer 28 notifies processor 74, which then outputs the secret information to display 64.

Although certain methods are described above with specific reference to device 60, the principles of these methods may be implemented, mutatis mutandis, using the more limited feature set of device 34, or using other information protection devices with other suitable combinations of features.

For example, FIG. 7 is a schematic pictorial illustration of an information protection device 140, in accordance with another embodiment of the present invention. In this embodiment, device 140 comprises a keyboard, which has a full set of alphanumeric keys 142 and, optionally, a numeric keypad 144. Device 140 connects to a standard personal computer via a standard connector 146, such as a USB connector, or via a wireless link, and is configured to perform all the operations of a conventional plug-in keyboard.

Unlike a conventional keyboard, however, device 140 comprises encryption processor 74, shown inside the device in cutaway view. Processor 74 in device 140 is configured to carry out the authentication and secure data entry functions that are described above. Operation of the encryption processor may be invoked by the user by toggling a suitable switch 148 between standby and active positions. In the standby position, processor 74 is dormant, and keystroke data are conveyed from keys 142 to the computer in the normal way. The user activates processor 74 (by flipping switch 148) when it is necessary to input secret data, such as an authentication password or credit card number. When activated, processor 74 encrypts the secret data entered by the user keystrokes, in the manner described above, so that the secret data cannot be accessed by an eavesdropper.

Alternatively or additionally, certain keys of device 140 may be dedicated for secret data entry, in which case switch 148 may not be required. For example, processor 74 may be configured to encrypt all data input via keypad 144, but not by keys 142.

Further alternatively or additionally, processor 74 in device 140 may automatically turn on encryption of user keystrokes at an appropriate time, possibly in response to a cue from the computer to which device 140 is connected. The computer may signal the processor to turn encryption on at an appropriate stage of interaction between the user and a page displayed on the computer screen, based on contents of the screen. For example, the computer may signal to processor 74 that the computer has detected a field on screen labeled “password.” When the user begins to enter data into this field, the processor turns encryption on.

Typically, device 140 also comprises an output transducer, such as display 64, for prompting the user to input secret data in the appropriate manner, for example, and indicating that the certificate presented by a given site is valid. In the example shown display 64 comprises a small LCD screen, which is present in many standard keyboards. Alternatively, indicator lamps or other indicators provided on the keyboard may be used for this purpose.

FIG. 8 is a schematic pictorial illustration of an information protection device 150, in accordance with an alternative embodiment of the present invention. Device 150 comprises an output connector 152, such as a USB connector, for connecting to a personal computer, and an input connector, such as a USB receptacle 154, for mating with an output connector 156 of a standard keyboard 158. Device 150 comprises an encryption processor, such as processor 74 (not shown in FIG. 8), which performs the authentication and secure data entry functions that are described above. In this case, however, keyboard 158 takes the place of the input transducer in the authentication devices that are shown in the preceding figures. Device 150 encrypts secret data entered by the user on keyboard 158 so that the secret data cannot be accessed by an eavesdropper.

Optionally, device 150 may comprise a switch (not shown in FIG. 8), like switch 148 in FIG. 7, for turning the encryption functions of the processor on and off. During normal data entry, when processor 74 is not needed, the user may thus switch the encryption function off. Alternatively, in the absence of a switch, the user may simply unplug connector 156 from receptacle 154 and plug the connector directly into the computer, or the user may connect a separate keyboard to the computer for normal data input and may use keyboard 158 (or possibly a smaller and more limited keypad) for entering secret data. Further alternatively or additionally, processor 74 may switch its encryption function on and off automatically, in response to cues from the computer, for example.

Device 150 may comprise an output transducer, such as an audio speaker 160, for purposes such as prompting the user to input secret data and indicating that a received certificate is valid. Alternatively or additionally, device 150 may perform this function by controlling an output transducer of keyboard 158, such as indicator lamps 162 or an alphanumeric display.

Devices 140 and 150 may also include the other features of device 60 (as shown in FIGS. 3A, 3B), such as biometric sensor 70 and token 78, and may be configured to perform all of the functions described above with reference to FIG. 4. Alternatively, device 150 may, for example, be configured to receive a biometric input from a sensor associated with keyboard 158 or from a separate, external sensor.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication, comprising:
coupling an information protection device to communicate via a local interface with a local computer operated by a user, the information protection device having an input transducer associated therewith;
initiating a communication session between the local computer and a remote computer over a network;
receiving in the information protection device an access code input by the user via the input transducer;
encrypting the access code in the information protection device using an encryption key held by the information protection device;
conveying the encrypted access code from the information protection device over the local interface to the local computer and from the local computer to the remote computer over the network; and
authenticating the user at the remote computer by decrypting the encrypted access code.

2. The method according to claim 1, and comprising conveying, from the information protection device over the local interface to the local computer and from the local computer to the remote computer over the network, an indication of an authentication token stored by the information protection device, wherein authenticating the user comprises verifying an identity of the user responsively to the indication.

3. The method according to claim 1, and comprising receiving in the information protection device a biometric input by the user via a biometric sensor, and conveying an indication of the biometric input from the information protection device over the local interface to the local computer and from the local computer to the remote computer over the network, wherein authenticating the user comprises verifying an identity of the user responsively to the indication.

4. The method according to claim 1, wherein the input transducer is selected from a group of input transducers consisting of a keypad and a keyboard.

5. The method according to claim 4, wherein the input transducer is configured to convey unencrypted input to the local computer responsively to keystrokes by the user.

6. The method according to claim 1, wherein the information protection device comprises a housing that contains the input transducer.

7. The method according to claim 1, wherein coupling the information protection device comprises plugging the input transducer into a connector of the information protection device.

8. The method according to claim 1, wherein the information protection device comprises an output transducer, for prompting the user to input the access code.

9. The method according to claim 9, and comprising conveying a certificate from the remote computer over the network to the local computer and verifying that the certificate is valid, wherein prompting the user comprises outputting via the output transducer an indication that the certificate is valid.

10. The method according to claim 1, and comprising, after authenticating the user, receiving information from the user via a user interface of the local computer for transmission from the local computer to the remote computer in the communication session.

11. The method according to claim 1, and comprising, after authenticating the user, receiving in the information protection device further information that is input by the user via the input transducer, and transmitting the further information in an encrypted form from the information protection device to the remote computer via a tunneled logical path through the local computer.

12. The method according to claim 1, wherein coupling the information protection device comprises plugging the information protection device into a receptacle in the local computer.

13. The method according to claim 1, wherein coupling the information protection device comprises establishing a short-range wireless link between the information protection device and the local computer.

14. The method according to claim 1, wherein encrypting the access code comprises conveying the encryption key from the remote computer over the network to the local computer and from the local computer over the local interface to the information protection device.

15. A method for communication, comprising:
coupling an information protection device to communicate via a local interface with a local computer operated by a user, the information protection device having an input transducer associated therewith;
establishing a physical communication link over a network between the local computer and a remote computer;
setting up a secure tunnel between the remote computer and the information protection device via the physical communication link and through the local computer, such that information transmitted through the secure tunnel is encrypted and can be decrypted only using a key that is unavailable to the local computer;
receiving data input by the user to the information protection device via the input transducer; and
encrypting and transmitting the data from the information protection device to the remote computer via the secure tunnel.

16. The method according to claim 15, wherein coupling the information protection device comprises plugging the information protection device into a receptacle in the local computer.

17. The method according to claim 15, wherein coupling the information protection device comprises establishing a short-range wireless link between the information protection device and the local computer.

18. The method according to claim 15, wherein the information protection device comprises a housing that contains the input transducer.

19. The method according to claim 15, wherein coupling the information protection device comprises plugging the input transducer into a connector of the information protection device.

20. The method according to claim 15, wherein the data input by the user via the input transducer comprise first data, and wherein the method comprises receiving second data input by the user via a user interface of the local computer, and transmitting the second data together with the first data to the remote computer via the physical communication link in a single communication session.

21. The method according to claim 20, wherein the input transducer comprises a keypad, and wherein the user interface comprises a keyboard.

22. The method according to claim 20, wherein the secure tunnel comprises a first secure socket connection, and wherein transmitting the second data comprises setting up a second secure socket connection between the information protection device and the local computer, and conveying the second data from the local computer through the second secure socket connection to the information protection device and from the information protection device through the first secure socket connection to the remote computer.

23. The method according to claim 15, wherein receiving the data comprises presenting a page provided by the remote computer on a display of the local computer, the page comprising a field to be filled in with the data input by the user.

24. The method according to claim 23, wherein the secure tunnel comprises a first secure socket connection, and wherein presenting the page comprises setting up a second secure socket connection between the information protection device and the local computer, and conveying the page from the remote computer through the first secure socket connection to the information protection device and from the information protection device through the second secure socket connection to the local computer.

25. The method according to claim 24, wherein presenting the page comprises generating an indication on the display that the field is to be filled in by the user by means of the input transducer of the information protection device.

26. The method according to claim 15, wherein the information protection device comprises an output transducer, for prompting the user to input the data.

27. The method according to claim 26, and comprising conveying a certificate from the remote computer over the network to the local computer and verifying that the certificate is valid, wherein prompting the user comprises outputting via the output transducer an indication that the certificate is valid.

28. A system for authenticating a user of a local computer, the system comprising:
a remote computer, which is configured to communicate over a network with the local computer;
an input transducer, which is coupled to receive an access code that is input by the user; and
an information protection device, which comprises:
a communication interface for communicating with a local interface of the local computer; and
an encryption processor, which is configured to encrypt the access code using an encryption key held by the information protection device and to convey the encrypted access code via the local interface to the local computer for transmission by the local computer to the remote computer over the network,
wherein the remote computer authenticates the user by decrypting the encrypted access code.

29. The system according to claim 28, wherein the information protection device comprises a memory that stores an authentication token, and is configured to convey an indication of the token through the local interface via the local computer to the remote computer over the network, and wherein the remote computer is configured to verify an identity of the user responsively to the indication.

30. The system according to claim 28, wherein the information protection device comprises a biometric sensor, which is coupled to receive a biometric input by the user, and wherein the information protection device is configured to convey an indication of the biometric input through the local interface via the local computer to the remote computer over the network, and wherein the remote computer is configured to verify an identity of the user responsively to the indication.

31. The system according to claim 28, wherein the input transducer is selected from a group of input transducers consisting of a keypad and a keyboard.

32. The system according to claim 31, wherein the input transducer is configured to convey unencrypted input to the local computer responsively to keystrokes by the user.

33. The system according to claim 32, wherein the information protection device comprises a switch that is operable to determine whether to convey data to the local computer responsively to the keystrokes in encrypted or unencrypted form.

34. The system according to claim 32, wherein the encryption processor is configured to switch automatically between conveying data in an encrypted form and in an unencrypted form in response to a signal from the local computer.

35. The system according to claim 28, wherein the information protection device comprises a housing that contains the input transducer.

36. The system according to claim 35, wherein the input transducer comprises an output connector, and the information protection device comprises an input connector for receiving the output connector.

37. The system according to claim 28, wherein the information protection device comprises an output transducer, which is configured to prompt the user to input the access code.

38. The system according to claim 37, wherein the remote computer is configured to convey a certificate over the network to the local computer, and wherein the information protection device is configured to verify that the certificate is valid and to prompt the user to input the access code in response to an indication that the certificate is valid.

39. The system according to claim 28, wherein the remote computer is configured to authenticate the user upon initiation of a communication session between the local computer and the remote computer, and to receive information that is input by the user via a user interface of the local computer in the communication session after authenticating the user.

40. The system according to claim 28, wherein the information protection device is configured to receive further information that is input by the user via the input transducer after the user has been authenticated, and to transmit the further information in an encrypted form to the remote computer via a tunneled logical path through the local computer.

41. The system according to claim 28, wherein the communication interface comprises a plug, which is configured to be received by a receptacle in the local computer.

42. The system according to claim 28, wherein the communication interface comprises a wireless interface, which is configured to establish a short-range wireless link with the local computer.

43. The system according to claim 28, wherein the remote computer is configured to transmit the encryption key over the network to the local computer, and wherein the information protection device is coupled to receive the transmitted encryption key transmitted from the local computer via the communication interface.

44. A system for communication by a user of a
local computer, the system comprising:
a remote computer, which is configured to establish a physical communication link with the local computer over a network;
an input transducer, which is coupled to receive data that are input by the user; and
an information protection device, which comprises:
a communication interface for communicating with a local interface of the local computer; and
a processor, which is configured to set up a secure tunnel to the remote computer over the physical communication link via the local computer, and to encrypt the received data for transmission via the secure tunnel to the remote computer such that the encrypted data transmitted through the secure tunnel can be decrypted only using a key held by the remote computer that is unavailable to the local computer.

45. The system according to claim 44, wherein the communication interface comprises a plug, which is configured to be received by a receptacle in the local computer.

46. The system according to claim 44, wherein the communication interface comprises a wireless interface, which is configured to establish a short-range wireless link with the local computer.

47. The system according to claim 44, wherein the information protection device comprises a housing that contains the input transducer.

48. The system according to claim 44, wherein the input transducer comprises an output connector, and the information protection device comprises an input connector for receiving the output connector.

49. The system according to claim 44, wherein the data input by the user via the input transducer comprise first data, and wherein the information protection device is configured to receive second data input by the user via a user interface of the local computer, and to transmit the second data together with the first data to the remote computer via the physical communication link in a single communication session.

50. The system according to claim 49, wherein the input transducer comprises a keypad, and wherein the user interface comprises a keyboard.

51. The system according to claim 49, wherein the secure tunnel comprises a first secure socket connection, and wherein the processor is configured to set up a second secure socket connection between the information protection device and the local computer, and to receive the second data from the local computer through the second secure socket connection and transmit the second data through the first secure socket connection to the remote computer.

52. The system according to claim 44, wherein the data comprise a page provided by the remote computer for presentation on a display of the local computer, the page comprising a field to be filled in with the data input by the user.

53. The system according to claim 52, wherein the secure tunnel comprises a first secure socket connection, and wherein the processor is configured to set up a second secure socket connection between the information protection device and the local computer, and to receive the page from the remote computer through the first secure socket connection and transmit the page through the second secure socket connection to the local computer.

54. The system according to claim 53, wherein the processor is configured to generate an indication on the display that the field is to be filled in by the user by means of the input transducer of the information protection device.

55. The system according to claim 44, wherein the information protection device comprises an output transducer, which is configured to prompt the user to input the data.

56. The system according to claim 55, wherein the remote computer is configured to convey a certificate over the network to the local computer, and wherein the information protection device is configured to verify that the certificate is valid and to output via the output transducer an indication that the certificate is valid.

57. An information protection device, for authenticating a user of a local computer on a remote computer, the device comprising:
a communication interface for communicating with a local interface of the local computer;
an input transducer, which is coupled to receive an access code that is input by the user;
a memory, which is configured to hold an encryption key; and
an encryption processor, which is configured to encrypt the access code using the encryption key and to convey the encrypted access code via the local interface to the local computer, so as to cause the encrypted access code to be conveyed via the local computer over a network to the remote computer, for authentication of the user by decryption of the encrypted access code.

58. The device according to claim 57, wherein the encryption processor is coupled to receive the encryption key from the local computer via the communication interface after transmission of the encryption key by the remote computer over the network to the local computer.

59. An information protection device for use by a user of a local computer, which is in communication with a remote computer via a physical communication link over a network the device comprising:
a communication interface for communicating with a local interface of the local computer;
an input transducer, which is coupled to receive data that are input by the user; and
a processor, which is configured to set up a secure tunnel to the remote computer over the physical communication link via the local computer, and to encrypt the received data for transmission via the secure tunnel to the remote computer such that the encrypted data transmitted through the secure tunnel can be decrypted only using a key held by the remote computer that is unavailable to the local computer.

60. An information protection device, for authenticating a user of a local computer on a remote computer, the device comprising:
a communication interface for communicating with a local interface of the local computer;
an input connector, which is configured to receive an output connector of an input transducer, which is operable by the user to input an access code;
a memory, which is configured to hold an encryption key; and
an encryption processor, which is configured to encrypt the access code using the encryption key and to convey the encrypted access code via the local interface to the local computer, so as to cause the encrypted access code to be conveyed via the local computer over the network to the remote computer, for authentication of the user by decryption of the encrypted access code.

61. An information protection device, for authenticating a user of a local computer on a remote computer, the device comprising:
a communication interface for communicating with a local interface of the local computer;
an input connector, which is configured to receive an output connector of an input transducer, which is operable by the user to input data; and
a processor, which is configured to set up a secure tunnel to the remote computer over a physical communication link via the local computer, and to encrypt the received data for transmission via the secure tunnel to the remote computer such that the encrypted data transmitted through the secure tunnel can be decrypted only using a key held by the remote computer that is unavailable to the local computer.
